(19) United States
(12) Patent Application Publication
(10) Pub. No.: US 2009/0310759 A1
(43) Pub. Date: Dec. 17, 2009

(54) METHOD FOR CONTENT-BASED PRIORITIZATION OF VOICE MESSAGES IN COMMUNICATIONS SYSTEM

(75) Inventors: Bernt Andrassy, Munchen (DE); Harald Höge, Gauting (DE)

Correspondence Address: STAAS & HALSEY LLP, SUITE 700, 1201 NEW YORK AVENUE, N.W., WASHINGTON, DC, 20005, US

(73) Assignee: SIEMENS AKTIENGESELLSCHAFT, MUNICH (DE)

(21) Appl. No.: 11/794,475

(22) PCT Filed: Oct. 4, 2005
(86) PCT No.: PCT/EP2005/054993

§ 371 Date: Aug. 18, 2009

(30) Foreign Application Priority Data
Dec. 30, 2004 (DE) 10 2004 063 556.0
Mar. 3, 2005 (DE) 10 2005 009 793.6

(51) Int. Cl. H04M 1/64

(52) U.S. Cl. 379/88.04; 704/E15.001

(57) ABSTRACT

Answering machines and voice mailbox systems are normally provided in modern communications systems. When a communications subscriber is temporarily unreachable at the location of their fixed network telephone, incoming calls can be accepted by an answering machine and voice messages can be recorded. The drawback of this procedure is that messages containing important information cannot be promptly conveyed to the communications subscriber. During incoming voice messages, their content is evaluated with the aid of a speech recognition system. As a result, content-based prioritization of voice messages is made possible in a communications system and the receiver is notified of the incoming voice messages according to the prioritization.

### CROSS REFERENCE TO RELATED APPLICATIONS

This application is based on and hereby claims priority to German Application No. 10 2004 063 556.0 filed on Dec. 30, 2004, and German Application No. 10 2005 009 793.6 filed on Mar. 3, 2005, the contents of both of which are hereby incorporated by reference.

### BACKGROUND

Answering machines and voice mailbox systems are normally provided in modern communications systems. When a communications subscriber is temporarily unreachable at the location of their fixed network telephone, incoming calls can be accepted by an answering machine. In this way, a preinstalled announcement message is generally conveyed to the caller by way of an answering machine, the announcement message including details about the person, the reason for their absence and a short request to leave a message. The caller may then recite a short voice message, which is recorded by the answering machine. When the communication subscriber is unreachable again at the location of their fixed network telephone, he/she for the most part receives a visual notification that his/her answering machine has recorded a message. The incoming voice messages can then be played back at the request of the called communication subscriber.

A further conceivable scenario would involve the communication subscriber having a mobile telephone terminal (mobile phone) and temporarily not wishing to or being unable to receive any calls, because he has to attend an important discussion or conference for instance. The possibility then exists for the communication subscriber of activating the voice mail box system by switching off his mobile telephone terminal, so that incoming calls are forwarded to the voice mailbox system and the caller is able leave a voice message there for the communication subscriber. After switching his/her mobile telephone on, the communication subscriber receives a written message (SMS: short message service) relating to the incoming calls. A telephonic connection with the voice mail box allows the communication subscriber to listen to the voice messages.

The drawback of this procedure is that messages containing important information cannot be promptly conveyed to the communications subscriber, if the communication subscriber has activated his/her answering machine system or his/her voice mailbox. The previous solutions assume that the communication subscriber regularly retrieves and listens to the incoming voice messages.

### SUMMARY

Described below is a method, with which a content-based prioritization of voice messages is enabled in a communication system and the receiver is notified about the incoming voice messages as a function of the prioritization.

Accordingly, in a method for content-based prioritization of voice messages the voice messages are conveyed in a communication system to an electronic message recording facility of a second communication subscriber by a first communication subscriber. With the aid of a speech recognition system, control characters are derived from the conveyed voice messages as a function of predeterminable recognition features. Predeterminable functions of the communication system can be made available as a function of the derived control characters. It is thus advantageously possible to determine the urgency of an incoming voice message on the basis of predeterminable recognition features, such as previously agreed alphanumeric code words, individual key words and/or specific combinations of key words for instance.

Without restricting the generality of this term, communication systems relate here to all wired and wireless networks for conveying messages between communication subscribers. Examples of this are the wired analog and digital (ISDN) fixed networks, the wireless communication services such as GSM and UMTS mobile radio services, as well as locally limited communication networks such as Bluetooth, Firewire, IrDA or WLAN. Furthermore, communication systems herewith include the corresponding terminals such as telephones, GSM and UMTS mobile radio terminals, PDAs (Personal Digital Assistants), Notebooks, Tablet, Pocket and Desktop PCs.

Without restricting the generality of this term, electronic message recording facilities are herewith systems for accepting calls and recording voice messages from the caller in analog and/or digital form. The term herewith includes both standalone answering machines and answering machines integrated in communication devices as well as network-integrated voice mailbox systems.

According to an advantageous embodiment, a message containing instructions and/or information is conveyed to the first communication subscriber connected to the electronic message recording facility. This message can be a general item of information for instance, such as “You have been connected to the fully-automated answering machine system of the XX family with the phone number 0xxx . . . ” or according to a priority analysis “Your message was forwarded to Mr. YZ and marked with a level of urgency of XX”. Furthermore, the message can contain instructions for further action, such as for instance “Please speak after the beep” or “Please leave your name and your company name”. It is thus advantageously possible on the one hand for the caller to receive the required information in a controlled dialog and on the other hand to inform the caller about the status of his/her call by way of feedback.

According to a further advantageous development, a message relating to the incoming voice message is conveyed to the second communication subscriber as a predeterminable function of the communication system and/or the first communication subscriber is connected to the preferably second communication subscriber. Accordingly, the message and/or the connection is conveyed as a function of predeterminable recognition features. A message may be announced for instance by an acoustic signal tone and may be explained by a short written message, if the call from a family member or a particularly important business partner has been recognized by speech recognition. Furthermore, the key words “company XY”, “bids” and “deadline” could have been determined from the voice message with the aid of speech recognition, so that the call is forwarded to the work-related contact of the second communication subscriber, such as the office for instance.

In particular, the urgency of the incoming voice message is determined with the aid of the recognition features. A message relating to the voice message and/or a connection with a predeterminable communication subscriber is then conveyed as a function of the determined urgency.

According to a further embodiment, the message contains a summary on the basis of the recognized voice message or on the basis of the recognized recognition features. In addition, the message can contain further information relating to the first communication subscriber, such as the name of the caller and the telephone number for instance. Furthermore, the message can contain further parameters relating to the incoming call, such as the time of its arrival, the duration of the voice message or the recognized key words for instance.

According to a further advantageous embodiment, an automated voice message is recognized with the aid of the determined recognition features. This is advantageous particularly with the automated recognition of telephony spam or spit (‘Spam over Internet Telephony’). Automated advertising calls from voice computers are usually also included here, with an artificially generated voice automatically leaving a text, in most cases an advertising message. These calls are generally carried out unrequested and constitute a significant nuisance to the recipient. The method allows such automated voice message to be recognized in advance and to be blocked with corresponding user specifications.

With an embodiment of the control program, the program sequence controller allows voice messages to be conveyed to an electronic message recording facility of a second communication subscriber by a first communication subscriber. Control characters are derived from the conveyed voice messages with the aid of a speech recognition system as a function of predeterminable recognition features. Predeterminable functions of the communication system can be made available as a function of the derived control characters.

### BRIEF DESCRIPTION OF THE DRAWINGS

These and other objects and advantages will become more apparent and more readily appreciated from the following description of an exemplary embodiment, taken in conjunction with the accompanying drawing, of which:

FIG. 1 is a block diagram of a method sequence for content-based prioritization of voice messages in a communication system.

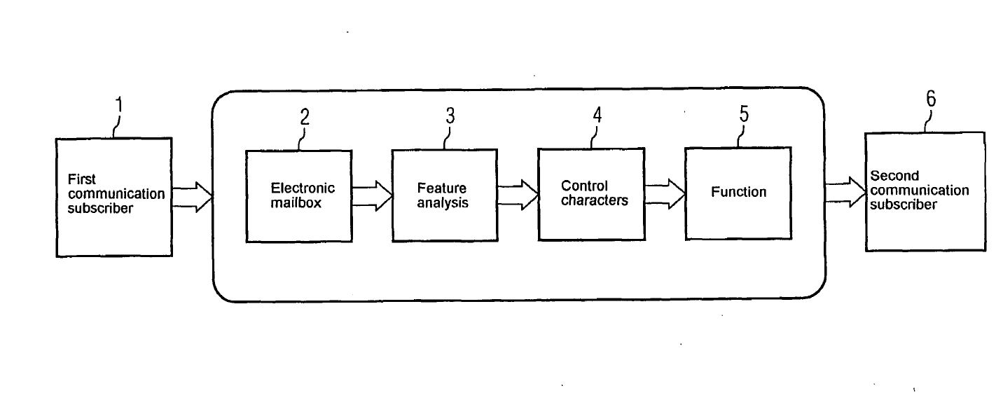

### DETAILED DESCRIPTION OF THE PREFERRED EMBODIMENT

Reference will now be made in detail to the preferred embodiments, examples of which are illustrated in the accompanying drawings, wherein like reference numerals refer to like elements throughout.

The FIGURE shows a first communication subscriber 1, who attempts to reach a second communication subscriber 6 by telephone. If the second communication subscriber 6 has activated an electronic message recording facility 2 of their communication system, the first communication subscriber 1 can leave a voice message on the electronic message recording facility. A feature analysis 3 is thus carried out by a speech recognition system of the recorded voice message of the first communication subscriber 1. Control characters 4 are derived from the voice message on the basis of the determined features. Predeterminable functions 5 are made available as a function of the derived control characters, the functions 5 being able to include a written notification of the second communication subscriber for instance.

According to a first possible application scenario, the second communication subscriber has an important meeting at work, during which he would prefer not to be disturbed by calls to his mobile. However, the birth of his first child is imminent and he is waiting every hour for a call from his heavily pregnant wife, which he does not want to miss. He thus configures the key words “birth”, “baby”, “labor” and “Anne” as predeterminable recognition features for a feature analysis of incoming voice messages.

Incoming voice messages are now routinely subject to a feature analysis, in which the predetermined key words are sought for instance with a “word spotting” method. A control character can now be derived when one or all of the predeterminable key words were identified. A control character can likewise be produced as a function of a predeterminable combination of identified key words.

If a voice message is detected by the communication system with the content “Hello John, this is Anne. I just wanted to tell you that the labor pains are getting stronger and Heidi is now taking me to the hospital, see you soon”, the key words “labor” and “Anne” are determined with the aid of a speech recognition method. The control character derived herefrom prompts the mobile of the second communication subscriber to compose an SMS message with information relating to the time and the recognized key words. The second communication subscriber is notified that he has received an important message by an acoustic signal tone.

A further application scenario is when the second communication subscriber has switched on his work answering machine system during a 2-week business trip.

When a call is made, special information relating to the caller is determined by targeted querying. By way of example, this can contain the request “Please leave your name and your company name”. The request can naturally also be carried out in a number of languages, such as English and German for instance.

Furthermore, an additional authentication query which comprises the query of an agreed alphanumeric code word can be carried out as a function of the recognized data. A further stage for increasing the recognition reliability of the urgency of a voice message can thus be introduced.

If the necessary data is determined in agreement with the specifications, a derived control character can effect the direct forwarding of the call to a predetermined representative or the office of the first communication subscriber for instance.

According to a further possible embodiment, context-based information can be conveyed to the caller as a function of the recognized key words. If an official context of the voice message is determined for instance, the job-related office hours of the recipient could be announced, such as for instance “We can be reached from Monday to Friday between 7 am and 5.30 pm”. If an important business partner has consequently been identified, the message could read “Mr. XY is currently in an important meeting and will call you back immediately” for instance.

According to a further exemplary embodiment, there is automatic recognition of telephony spam or spit (‘Spam over Internet Telephony’). Automatic advertising calls from voice computers are typically included here, with an artificially generated voice automatically leaving a text, mostly advertising messages. These calls generally occur unrequested and constitute a significant nuisance to the recipient. The method allows calls from such voice computers to already be recognized in advance and blocked with corresponding user specifications.

An incoming caller is generally queried for instance in a method for rejecting spit. The query can be carried out by way of a previously recorded voice signal or by way of a speech synthesis system. The query requires the caller to communicate his/her name or his/her terminal identification (“Please leave your name” or “Please leave your terminal identification”). A voice computer is unable to react to such a query in a flexible fashion and will, accordingly, answer out of context or not at all. A speech recognition system allows the answer to be determined and a corresponding control character is derived therefrom. If the voice computer responds to a targeted question, such as “Are you a voice computer?”, by reading out his/her advertising message (“You have the possibility of winning a fortune from XY lottery”), the speech recognition system recognizes the absence of a meaningful answer. A control character is thus derived, which prompts the communication system to interrupt the communication link for instance. Furthermore, a message can also be created for the recipient by the communication system, in which message information is provided about the incoming spam call by the associated link identifier.

According to a further variant of the embodiment for recognizing telephony spam or spit, speech recognition is regularly carried out during incoming calls by way of a speech recognition system. The speech recognition system recognizes on the basis of the voice of the caller, whether this is a human voice or a voice synthesized by a machine. If a synthesized voice is now recognized by the speech recognition system, a control character is derived, by which the communication link is interrupted by the communication system for instance.

A description has been provided with particular reference to an exemplary embodiment and examples, but it will be understood that variations and modifications can be effected within the spirit and scope of the claims which may include the phrase “at least one of A, B and C” as an alternative expression that means one or more of A, B and C may be used, contrary to the holding in Superguide v. DIRECTV, 358 F3d 870, 69 USPQ2d 1865 (Fed. Cir. 2004).

1-11. (canceled)

12. A method for content-based prioritization of voice messages in a communication system, comprising:
receiving voice messages of a first communication subscriber at an electronic message recording facility of a second communication subscriber;
deriving control characters from the voice messages as a function of predeterminable recognition features using a speech recognition system; and
providing predeterminable functions of the communication system based on the control characters derived.

13. The method as claimed in claim 12, wherein the predeterminable recognition features are predeterminable keywords.

14. The method as claimed in claim 13, further comprising conveying a message containing at least one of instructions and information to the first communication subscriber via the electronic message recording facility.

15. The method as claimed in claim 14, wherein said providing includes at least one of
conveying a message, relating to an incoming voice message, to the second communication subscriber as one of the predeterminable functions of the communication system, and
connecting the first communication subscriber to the second communication subscriber.

16. The method as claimed claim 15,
further comprising determining an urgency of the voice message based on the predeterminable recognition features, and
wherein the message relating to the voice message is conveyed based on at least one of a function of the urgency determined and with urgency information relating to the urgency determined.

17. The method as claimed in 16, wherein the message is communicated as at least one of readable and audible.

18. The method as claimed in 17, wherein the message contains a summary of the voice message based on at least one of a recognized voice message produced by the speech recognition system and the predeterminable recognition features.

19. The method as claimed in 18, wherein the message contains further information relating to the first communication subscriber, including at least one of name and telephone number, and relating to the incoming voice message, including at least one of time of arrival and recognized keywords.

20. The method as claimed in 19, further comprising automatically recognizing receipt of an automated voice message based on the predeterminable recognition features.

21. The method as claimed in 12, wherein the predeterminable recognition features are determined using the speech recognition system.

22. At least one computer readable memory encoded with a control program that when loaded into a working memory of a program sequence controller causes the program sequence controller to perform a method comprising:
receiving voice messages of a first communication subscriber at an electronic message recording facility of a second communication subscriber;
deriving control characters from the voice messages as a function of predeterminable recognition features using a speech recognition system; and
providing predeterminable functions of the communication system based on the control characters derived.
